(19) United States
(12) Patent Application Publication
(10) Pub. No.: US 2011/0296121 A1
(43) Pub. Date: Dec. 1, 2011

(54) DATA WRITING METHOD AND COMPUTER SYSTEM

(76) Inventor: Hsu-Ming Lee, Taipei Hsien (TW)

(21) Appl. No.: 12/900,455

(22) Filed: Oct. 7, 2010

(30) Foreign Application Priority Data
May 27, 2010 (TW) 099116985

(51) Int. Cl. G06F 12/00

(52) U.S. Cl. 711/155; 711/E12.001

(57) ABSTRACT

A data writing method for a storage device includes utilizing the storage device to transmit identification information according to a data writing request from a processing unit, utilizing the processing unit to transmit data writing information corresponding to the identification information according to the identification information, and utilizing the storage device to perform a data writing process according to the data writing information.

### BACKGROUND OF THE INVENTION

1. Field of the Invention

The present invention relates to a data writing method and related computer system, and more particularly, to a data writing method capable of preventing writing error occurrences due to unexpected external events and related computer system.

2. Description of the Prior Art

A memory device is an essential part of an electronic product. The memory device is usually utilized for storing digital data and programs to be accessed by a processor. Now, many electronic products can offer multiple functions, such as multimedia, mobile, and network functions, each of which demands more memory device allocation for its application. In general, memory is classified into two types: one time programmable memory and multi-time programmable memory. A one time programmable memory, such as a read only memory (ROM), can only be programmed once. As soon as data is written into the one time programmable memory, the one time programmable memory cannot be erased and rewritten to update the data. A multi-time programmable memory, such as a flash memory, can be written, erased and rewritten many times.

Although the multi-time programmable memory provides excellent convenience of use, the multi-time programmable memory may experience error occurrences. Therefore, for preventing the data stored in the memory device from being deleted or overwritten by unexpected data accidentally, the prior art usually adopts a writing protection scheme for the memory device by using a software or hardware design for protecting the data. For example, the prior art may set a writing protection period for the memory device by using software configuration, and utilize commands to limit any writing or erasing operation performed in the memory device during the writing protection period. As a result, the data stored in the memory device will not be varied if the memory device encounters any external factors during the writing protection period. In addition, the prior art can also use hardware design to provide the writing protection scheme. For example, the prior art may use an embedded controller to restrict the writing process of the memory device through controlling general purpose input output (GPIO) pins, and therefore, the memory device can avoid error writing or error erasing occurrences during the writing protection period.

As can be seen, the writing protection schemes designed with software or hardware of the prior art only prevent erroneous writing to the memory device during the writing protection period. However, in some situations, the memory device may also suffer the erroneous writing outside the writing protection period. For example, during a data writing period (allowable for performing a normal data writing process in the memory device), the data stored in the memory may be destroyed due to an instable power supply, instable control signal, or an unexpected power problem in the instant that power is turned on or off. Part or all of data stored in the memory may be overwritten or erased wrongly, causing permanent damage. Therefore, the data stored in the memory may be corrupted or incomplete, and therefore nonfunctional. Also, if the data stored in the memory is related to system data, such as a basic input output system (BIOS) code or an embedded controller (EC) code, the computer system will fail to perform normal operations.

Please refer to FIG. 1, which is a schematic diagram illustrating a data writing operation and a writing protection operation according to the prior art. Suppose a period X (timing point A to timing point B) and a period Z (timing point C to timing point D) are, respectively, writing protection periods, and a period Y (timing point B to timing point C) is a data writing period. This means the memory device is set in a writing protection state during the periods X and Z, and moreover, any data writing or erasing process can be performed in the memory during the period Y. Suppose the power supply is removed during the period Y, causing an unexpected power variation due to the influence of capacitance effect, a pseudo signal S is generated to the memory device accordingly (for example, assuming the pseudo signal S is generated at the timing point C′). In such a situation, the pseudo signal S may be mistaken for a normal data writing signal by the memory device, so that an unexpected data is written to the memory device, causing an erroneous writing situation. Moreover, the above-mentioned error writing occurrences may affect the reliability and completeness of data stored in the memory device. Therefore, designing a safe and accurate data writing method for the computer system when the normal data writing process is performed in a memory device without external disturbance should be a concern in progressive system design.

### SUMMARY OF THE INVENTION

It is therefore an objective of the invention to provide a data writing method and computer system.

The present invention discloses a data writing method for a storage device, which includes utilizing the storage device to transmit identification information according to a data writing request from a processing unit, utilizing the processing unit to transmit data writing information corresponding to the identification information according to the identification information, and utilizing the storage device to perform a data writing process according to the data writing information.

The present invention further discloses a computer system, including a processing unit, and a storage device coupled to the processing unit, wherein after the storage device receives a data writing request from the processing unit and transmits identification information to the processing unit accordingly, the processing unit transmits data writing information to the storage device according to the identification information, and the storage device performs a data writing process according to the data writing information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating the data writing operation and the writing protection according to the prior art.

FIG. 2 is a schematic diagram of a computer system according to an embodiment of the invention.

FIG. 3 is a schematic diagram of a procedure according to an embodiment of the invention.

### DETAILED DESCRIPTION

To ensure that a storage device of a computer system does not suffer erroneous writing situations due to unexpected external factors, the invention offers a security identification scheme for the storage device before performing all operating processes that vary data in the storage device, such as data writing or data erasing operations. In other words, the corresponding operating processes can be performed in the storage devices after satisfying security identification requirements so as to avoid any possible erroneous writing situations and enhance the reliability and completeness of data stored in the storage device.

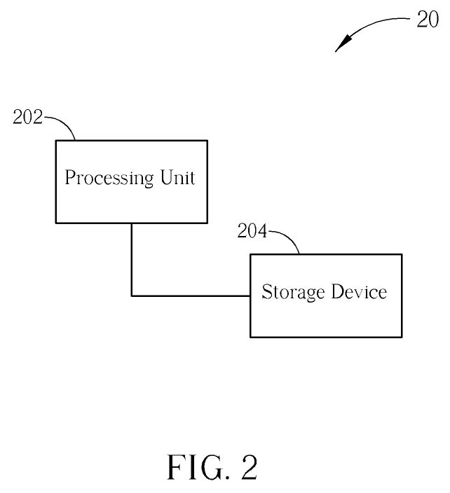

Please refer to FIG. 2, which is a schematic diagram of a computer system 20 according to an embodiment of the invention. The computer system 20 includes a processing unit 202 and a storage device 204. The storage device 204 is utilized for storing data. The processing unit 202 is capable of accessing the data stored in the storage device 204. In the embodiment, the storage device 204 can be a flash memory, but this should not be a limitation of the invention. When the computer system 20 has a data writing requirement (i.e. the data needs to be written into the storage device 204), the processing unit 202 can control the storage device 204 to perform a data writing process through corresponding commands during a data writing period so as to store the data into the storage device 204. Note that, in the embodiment, the storage device 204 is able to accomplish the data writing process or other relative data variation processes according to the corresponding commands. The storage device 204 can transmit the corresponding identification information to the corresponding processing unit for security identification before performing the data writing process, and furthermore, the storage device 204 can also determine whether the replied information transmitted by the processing unit contains the transmitted identification information for verifying authenticity of a data writing request from the processing unit 202.

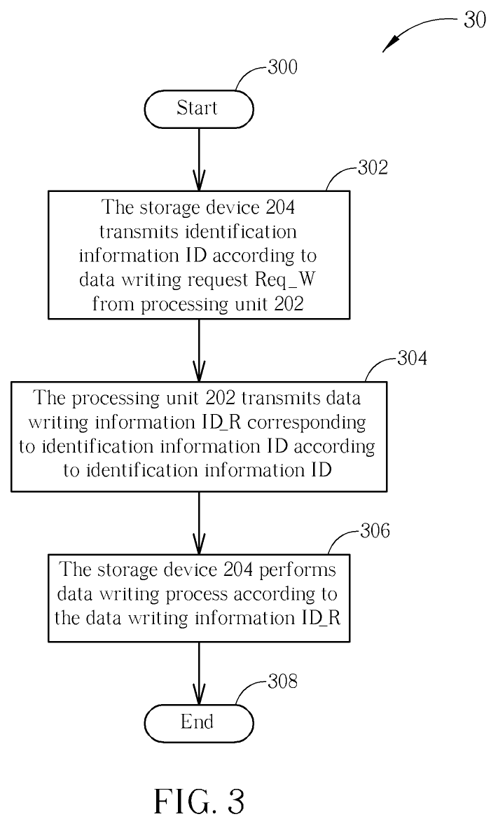

Operations of writing data to the storage device 204 in the computer system 20 can be summarized in a data writing process 30 as shown in FIG. 3. The data writing process 30 includes the following steps:

Step 300: Start.

Step 302: The storage device 204 transmits identification information ID according to data writing request Req_W from processing unit 202.

Step 304: The processing unit 202 transmits data writing information ID_R corresponding to identification information ID according to identification information ID.

Step 306: The storage device 204 performs data writing according to the data writing information ID_R.

Step 308: End.

Further description associated with the data writing process 30 follows. In Step 302, when the data needs to be written to the storage device 204, the processing unit 202 is capable of transmitting the data writing request Req_W to the storage device 204. The data writing request Req_W includes commands for executing data writing and/or data needing to be written, and this should not be a limitation of the invention. After receiving the data writing request Req_W, the storage device 204 transmits a corresponding identification information ID accordingly to inform the processing unit 202 that the data writing request Req_W has been received. In other words, the identification information ID can be regarded as the security identification for the storage device 204 before performing the data writing process. Furthermore, the identification information ID can be appended to the reply information by the processing unit 202. When the storage device 204 determines that the identification information ID exists in the reply information, this means the data writing request Req_W is certainly a request command from the processing unit 202, and therefore, the storage device 204 can perform the corresponding operations accordingly.

In Step 304, the processing unit 202 replies with the data writing information ID_R to the storage device 204 accordingly after receiving the identification information ID from the storage device 204. The data writing information ID_R at least includes the data writing request Req_W and the identification information ID. As a result, through the data writing information ID_R, the storage device 204 can confirm that the data writing request Req_W received in Step 302 is certain to be transmitted by the processing unit 202.

Furthermore, in Step 306, the storage device 204 determines whether the data writing information ID_R contains the data writing request Req_W transmitted by the processing unit 202 and the identification information ID originally transmitted in the previous step by the storage device 204. When the storage device 204 determines that the data writing information ID_R certainly contains the data writing request Req_W and the identification information ID, the storage device 204 then performs the data writing process according to the data writing request Req_W for realizing the data writing purpose. Otherwise, when the storage device 204 determines that the data writing information ID_R does not contain the data writing request Req_W and the identification information ID, the storage device 204 stops relative operations without performing the data writing process. In detail, if the storage device 204 examines the contents of the identification information ID and determines that the data writing information ID_R only contains the identification information ID, this means the data writing request Req_W originally received by the storage device 204 is a wrong request signal due to unexpected events occurring in the computer system 20 (for example, an unstable power source resulting in a signal variation situation, and the signal variation situation being mistaken as a normal data request signal by the storage device 204). In brief, the storage device 204 can perform the corresponding data writing process according to the corresponding data writing request Req_W after determining that the data writing information ID_R certainly contains the data writing request Req_W and the identification information ID. During a data writing period (i.e. the period without data writing limitation of data writing protection), the invention can ensure that the data writing request Req_W is exactly the writing request transmitted by the processing unit 202 without other error indications caused by external factors after the storage device 204 receives the data writing request Req_W. Therefore, the invention can effectively prevent the erroneous writing situations due to human factors or unexpected factors.

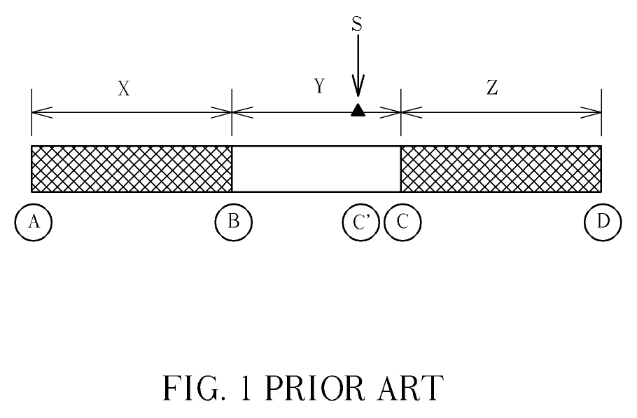

As stated in the prior art, the writing error occurrence often occurs during the periods during which data writing operation is allowed (e.g. the data writing period Y shown in FIG. 1). Comparatively, the invention can perform the corresponding data writing process after verifying the accuracy of the data writing request, so as to avoid the writing error occurrence effectively. In other words, the invention can provide a secondary protection for preventing the writing error occurrences due to unexpected external factors outside the data writing protection scheme.

Note that, the computer system 20 shown in FIG. 2 represents an exemplary embodiment of the invention and those skilled in the art can make alterations and modifications accordingly. For example, the computer system 20 can be a notebook, a personal computer, or an embedded system, and this should not be a limitation of the invention. The processing unit 202 can be any kind of device which can generate write commands to the storage device 204 for accessing data stored in the storage device 204, such as a central processing unit, an embedded controller, a microprocessor, or any other similar element having the same function. The storage device 204 can be any kind of memory which can be read or written repeatedly, such as a flash memory. In addition, the above-mentioned data writing process includes all operating processes that vary data in the storage device 204, such as a data writing process performed in the storage device 204, a data erasing process performed in the storage device 204, etc.

In summary, the invention can perform the corresponding data writing process after verifying accuracy of the data writing request so as to avoid the writing error occurrence and enhance writing protection effect.

Those skilled in the art will readily observe that numerous modifications and alterations of the device and method may be made while retaining the teachings of the invention.

What is claimed is:

1. A data writing method for a storage device, the data writing method comprising:
utilizing the storage device to transmit identification information according to a data writing request from a processing unit;
utilizing the processing unit to transmit data writing information corresponding to the identification information according to the identification information; and
utilizing the storage device to perform a data writing process according to the data writing information.

2. The data writing method of claim 1, wherein the step of utilizing the storage device to transmit the identification information according to the data writing request from the processing unit comprises:
utilizing the storage device to receive the data writing request from the processing unit; and
utilizing the storage device to transmit the identification information according to the data writing request.

3. The data writing method of claim 1, wherein the data writing information comprises the identification information transmitted by the storage device and the data writing request transmitted by the processing unit.

4. The data writing method of claim 3, wherein the step of utilizing the storage device to perform the data writing process according to the data writing information comprises:
utilizing the storage device to determine whether the identification information included in the data writing information conforms to the original identification information transmitted by the storage device;
when the determining result is conformity, performing the data writing process according to the data writing information; and
when the determining result is inconformity, stopping performing operations.

5. The data writing method of claim 1, wherein the storage device is utilized for storing a basic input/output system code or an embedded control code.

6. A computer system comprising:
a processing unit; and
a storage device coupled to the processing unit;
wherein after the storage device receives a data writing request from the processing unit and transmits identification information to the processing unit accordingly, the processing unit transmits data writing information to the storage device according to the identification information, and the storage device performs a data writing process according to the data writing information.

7. The computer system of claim 6, wherein the data writing information comprises the identification information transmitted by the storage device and the data writing request transmitted by the processing unit.

8. The computer system of claim 7, wherein when the storage device determines that the identification information included in the data writing information is identical to the original identification information transmitted by the storage device, the storage device performs the data writing process according to the data writing information.

9. The computer system of claim 7, wherein when the storage device determines that the identification information included in the data writing information is not identical to the original identification information transmitted by the storage device, the storage device stops performing operations.

10. The computer system of claim 6, wherein the storage device is utilized for storing a basic input/output system code or an embedded control code.
